(19) United States
(12) Patent Application Publication
(10) Pub. No.: US 2022/0044565 A1
(43) Pub. Date: Feb. 10, 2022

(54) Method and Device for Determining Road Condition of Vehicle, Computer Storage Medium and Vehicle

(71) Applicant: Robert Bosch GmbH, Stuttgart (DE)

(72) Inventors: Luoyi Huang, Suzhou (CN); Zhuowei Han, Suzhou (CN)

(21) Appl. No.: 17/381,646

(22) Filed: Jul. 21, 2021

(30) Foreign Application Priority Data
Aug. 4, 2020 (CN) 202010771905.4

(51) Int. Cl. G08G 1/0967

(52) U.S. Cl. CPC G08G 1/096783

(57) ABSTRACT

A method for determining a road condition of a vehicle is disclosed. The method includes (i) receiving a first signal from a road side unit, the first signal indicating a positional relationship between the vehicle and a specific region, and (ii) determining a road condition of the vehicle on the basis of the first signal. A device for determining a road condition of a vehicle, a computer storage medium and a vehicle are also disclosed.

This application claims priority under 35 U.S.C. § 119 to patent application no. CN 202010771905.4, filed on Aug. 4, 2020 in China, the disclosure of which is incorporated herein by reference in its entirety.

The present disclosure relates to the field of autonomous driving, in particular to a method and device for determining a road condition of a vehicle, a computer storage medium and a vehicle.

### BACKGROUND

An autonomous driving system is generally designed to have its own design travelling region or operational design domain (ODD); the design travelling region includes the road condition, e.g. highway, urban road, country road, etc.

In the prior art, the road condition ahead is generally determined by high-precision positioning and high-precision maps. However, due to problems with the accuracy and robustness of high-precision positioning, deviation in positioning can arise, resulting in inaccurate information. Furthermore, high-precision maps are classed as prior information which is not real-time; if a map is out of date or has not been updated in a timely fashion, this will similarly result in inaccuracy in the road information provided.

Thus, a more efficient solution for determining a road condition of a vehicle is desired.

### SUMMARY

According to an aspect of the present disclosure, a method for determining a road condition of a vehicle is provided, the method comprising: receiving a first signal from a road side unit, the first signal indicating a positional relationship between the vehicle and a specific region; and determining a road condition of the vehicle on the basis of the first signal.

As an alternative or addition to the above solution, in the method, the road side unit is an ETC master computer device located at a boundary of the specific region.

As an alternative or addition to the above solution, in the method, the first signal is an ETC signal, which indicates that the vehicle is entering or leaving the specific region.

As an alternative or addition to the above solution, in the method, the step of determining a road condition of the vehicle on the basis of the first signal comprises: judging whether a value of the first signal is 1; if so, then determining that the vehicle is currently entering the specific region.

As an alternative or addition to the above solution, in the method, the step of determining a road condition of the vehicle on the basis of the first signal further comprises: when the value of the first signal is 0, determining that the vehicle is currently leaving the specific region.

As an alternative or addition to the above solution, in the method, the specific region is a highway, a car park, a microdistrict or a factory area.

As an alternative or addition to the above solution, the method further comprises: receiving a second signal from the road side unit, the second signal containing supplementary information for determining a road condition of the vehicle.

According to another aspect of the present disclosure, a device for determining a road condition of a vehicle is provided, the device comprising: a first receiving means, for receiving a first signal from a road side unit, the first signal indicating a positional relationship between the vehicle and a specific region; and a determining means, for determining a road condition of the vehicle on the basis of the first signal.

As an alternative or addition to the above solution, in the device, the road side unit is an ETC master computer device located at a boundary of the specific region.

As an alternative or addition to the above solution, in the device, the first signal is an ETC signal, which indicates that the vehicle is entering or leaving the specific region.

As an alternative or addition to the above solution, in the device, the determining means is configured to judge whether a value of the first signal is 1, and determine that the vehicle is currently entering the specific region when the value of the first signal is 1.

As an alternative or addition to the above solution, in the device, the determining means is further configured to determine that the vehicle is currently leaving the specific region when the value of the first signal is 0.

As an alternative or addition to the above solution, in the device, the specific region is a highway, a car park, a microdistrict or a factory area.

As an alternative or addition to the above solution, the device further comprises: a second receiving means, for receiving a second signal from the road side unit, the second signal containing supplementary information for determining a road condition of the vehicle.

According to another aspect of the present disclosure, a computer storage medium is provided, the medium comprising instructions which, when run, execute the method for determining a road condition of a vehicle as described above.

According to another aspect of the present disclosure, a vehicle is provided, comprising the device for determining a road condition of a vehicle as described above.

In summary, the solution for determining a road condition of a vehicle in embodiments of the present disclosure can determine a road condition during autonomous driving of a vehicle with the aid of information provided by a road side unit. The solution does not need to frequently perform map navigation and corresponding processing analysis, so is simpler and more efficient.

### BRIEF DESCRIPTION OF THE DRAWINGS

The following detailed explanation in conjunction with the drawings will make the abovementioned and other objectives and advantages of the present disclosure more complete and clear, wherein identical or similar key elements are indicated with identical labels.

FIG. 1 shows a schematic flow chart of the method for determining a road condition of a vehicle according to an embodiment of the present disclosure; and

FIG. 2 shows a structural schematic diagram of a device for determining a road condition of a vehicle according to an embodiment of the present disclosure.

### DETAILED DESCRIPTION

To clarify the object, technical solution and advantages of the present disclosure, particular embodiments of the present disclosure are described in further detail below in conjunction with the drawings. As will be understood, the particular embodiments described here are merely intended to explain the present disclosure, without limiting it.

It should also be explained that for convenience of description, the drawings only show those parts which are relevant to the present disclosure, not all content. Before discussing exemplary embodiments in greater detail, it should be mentioned that some exemplary embodiments are described as the processing or method depicted in the flow chart. Although the flow chart describes the operations (or steps) as sequential processing, many of the operations can be implemented in parallel, concurrently or simultaneously. In addition, the sequence of the operations can be rearranged. When the operations are complete, the processing can be terminated, but there may also be additional steps not included in the drawings. The processing may correspond to methods, functions, rules, subroutines, subprograms, etc.

The solution for determining a road condition of a vehicle according to the exemplary embodiments of the present disclosure is described in detail below with reference to the drawings.

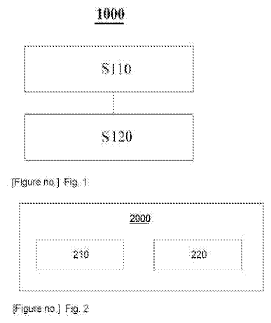

FIG. 1 shows a schematic flow chart of the method for determining a road condition of a vehicle according to an embodiment of the present disclosure. As shown in FIG. 1, the method 1000 comprises the following steps:

In step S110, a first signal is received from a road side unit, the first signal indicating a positional relationship between the vehicle and a specific region; and
in step S120, a road condition of the vehicle is determined on the basis of the first signal.

In the context of the present disclosure, the term “road side unit” is also called “roadside unit”, “road side unit device” or RSU (Road Side Unit), and is generally installed at the side of a road. In general, a road side unit communicates with an on-board unit (OBU, On Board Unit) by a technology such as DSRC (Dedicated Short Range Communication) or C-V2X, and thereby realizes functions such as vehicle identity recognition and the electronic deduction of points.

ODD stands for Operational Design Domain, i.e. design travelling region, and refers to an environment in which a self-driving motor vehicle can operate safely. It generally includes the road condition, speed, terrain, environment, traffic situation, time period, etc. when the vehicle is being driven autonomously. Put simply, ODD is the scope of application of autonomous driving. Since existing autonomous driving technology is still at the development stage, for the time being it is not possible to guarantee that a self-driving vehicle can travel safely in any weather conditions and any road environment. Thus, it is necessary to set an ODD in advance according to the technological capability of the self-driving system, and by restricting the travelling environment and travelling method, provide against possible accidents. This is because self-driving performance might be affected by a series of conditions, e.g. high speed or low speed, plain or mountainous area, straight road or curved road, what the weather is like, what the infrastructure is like, whether the traffic situation is simple or complex, whether it is day or night, etc.

As stated above, ODD conditions include the road condition. In the context of the present disclosure, the term “road condition of the vehicle” means a road condition of current travelling of the vehicle, including highway or ordinary road, lane or sidewalk, as well as a lane specifically for self-driving vehicles, etc.

Using the solution of the method 1000, the road condition of the vehicle can be determined with the aid of the first signal provided by the road side unit. The solution ensures recognition accuracy while also reducing the complexity of implementation of the entire solution. Moreover, if all of the preconditions set in a design driving region are satisfied (including an already satisfied road condition), the autonomous driving system can guarantee normal operation of the vehicle. If any precondition is not satisfied in the course of autonomous driving, then in order to avoid a possible fault, the autonomous driving system can allow the driver to take manual control or take action to perform an emergency stop.

In one embodiment, the road side unit (RSU) is an ETC master computer device located at a boundary of a specific region. The specific region may for example be a dedicated lane for a vehicle, a park area, a factory area, a microdistrict, a car park or a highway, etc. In one particular implementation, the road side unit (RSU) is an ETC gate device located at a highway toll gate or exit.

ETC (Electronic Toll Collection), an electronic system for charging without stopping a vehicle, is an automatic charging system for highways or bridges. Through dedicated short-range communication conducted between an on-board electronic tag mounted on the vehicle windshield for example and a microwave antenna on a toll station ETC lane, computer networking technology is used to perform background settlement processing with a bank, thereby achieving the objective of enabling payment of the highway or bridge toll without any need to stop when the vehicle is passing the highway or bridge toll station. In one or more embodiments of the present disclosure, a receiving means (e.g. an on-board unit (OBU), an RFID device or an ETC device) is mounted on the vehicle, and communicates with a road side unit (RSU), e.g. receives a first signal from the road side unit, the first signal indicating a positional relationship between the vehicle and a specific region.

In one or more embodiments, the first signal is an ETC signal, which indicates that the vehicle is entering or leaving the specific region. For example, the first signal indicates that the vehicle is entering or leaving a highway. As another example, the first signal indicates that the vehicle is entering or leaving a park area.

In one or more embodiments, step S120 comprises: judging whether a value of the first signal is 1; if so, then determining that the vehicle is currently entering the specific region. The step S120 may further comprise: when the value of the first signal is 0, determining that the vehicle is currently leaving the specific region. In a highway scenario, when the value of the first signal is 1, the first signal indicates that the vehicle is currently entering the highway. Thus, based on the value of the received first signal, a judgment can be made that the road condition of the vehicle is “highway”. The autonomous driving system can further determine whether ODD conditions are currently satisfied on the basis of a signal measured by itself and/or an externally received signal.

Although not shown in FIG. 1, in one embodiment, the method 1000 may further comprise: receiving a second signal from the road side unit, the second signal containing supplementary information for determining a road condition of the vehicle. For example, the second signal may be information for assisting in the determination of a road condition of the vehicle, such as the number of lanes in the highway, the congestion situation on the highway, etc., and can vary with actual circumstances.

Referring to FIG. 2, FIG. 2 shows a structural schematic diagram of a device 2000 for determining a road condition of a vehicle according to an embodiment of the present disclosure. As shown in FIG. 2, the device 2000 for determining a road condition of a vehicle comprises a first receiving means 210 and a determining means 220, wherein the first receiving means 210 is configured to receive a first signal from a road side unit, the first signal indicating a positional relationship between the vehicle and a specific region. The determining means 220 is configured to determine a road condition of the vehicle on the basis of the first signal.

In the context of the present disclosure, the term “road side unit” is also called “roadside unit”, “road side unit device” or RSU (Road Side Unit), and is generally installed at the side of a road. In general, a road side unit communicates with an on-board unit (OBU, On Board Unit) by a technology such as DSRC (Dedicated Short Range Communication) or C-V2X, and thereby realizes functions such as vehicle identity recognition and the electronic deduction of points.

In the context of the present disclosure, the term “road condition of the vehicle” means a road condition of current travelling of the vehicle, including highway or ordinary road, lane or sidewalk, as well as a lane specifically for self-driving vehicles, etc.

Via the device 2000 for determining a road condition of a vehicle, the first signal can be received from the road side unit by means of the first receiving means 210, and the determining means 220 determines the road condition of the vehicle on the basis of the received first signal. The solution ensures recognition accuracy while also reducing the complexity of implementation of the entire solution.

In one embodiment, the road side unit (RSU) is an ETC master computer device located at a boundary of a specific region. The specific region may for example be a dedicated lane for a vehicle, a park area, a factory area, a microdistrict, a car park or a highway, etc. In one particular implementation, the road side unit (RSU) is an ETC gate device located at a highway toll gate or exit.

ETC (Electronic Toll Collection), an electronic system for charging without stopping a vehicle, is an automatic charging system for highways or bridges. Through dedicated short-range communication conducted between an on-board electronic tag mounted on the vehicle windshield for example and a microwave antenna on a toll station ETC lane, computer networking technology is used to perform background settlement processing with a bank, thereby achieving the objective of enabling payment of the highway or bridge toll without any need to stop when the vehicle is passing the highway or bridge toll station. In one or more embodiments of the present disclosure, a first receiving means (e.g. an on-board unit (OBU), an RFID device or an ETC device) is mounted on the vehicle, and communicates with a road side unit (RSU), e.g. receives a first signal from the road side unit, the first signal indicating a positional relationship between the vehicle and a specific region.

In one or more embodiments, in the device 2000, the first signal is an ETC signal, which indicates that the vehicle is entering or leaving the specific region. For example, the first signal indicates that the vehicle is entering or leaving a highway. As another example, the first signal indicates that the vehicle is entering or leaving a park area.

In one or more embodiments, the determining means 220 is configured to judge whether a value of the first signal is 1; and if so, then determine that the vehicle is currently entering the specific region. The determining means 220 may be further configured to determine that the vehicle is currently leaving the specific region when the value of the first signal is 0. In a highway scenario, when the value of the first signal is 1, the first signal indicates that the vehicle is currently entering the highway. Thus, based on the value of the received first signal, the determining means 220 can judge that the road condition of the vehicle is “highway”. Correspondingly, the autonomous driving system can further determine whether ODD conditions are currently satisfied on the basis of a signal measured by itself and/or an externally received signal.

Although not shown in FIG. 2, in one embodiment, the device 2000 for determining a road condition of a vehicle further comprises a second receiving means, configured to receive a second signal from the road side unit, the second signal containing supplementary information for determining a road condition of the vehicle. For example, the second signal may be information for assisting in the determination of a road condition of the vehicle, such as the number of lanes in the highway, the congestion situation on the highway, etc., and can vary with actual circumstances.

Those skilled in the art will readily understand that the method for determining a road condition of a vehicle as provided in one or more embodiments of the present disclosure can be implemented by means of a computer program. For example, when a computer storage medium (e.g. a USB stick) storing the computer program is connected to a computer, the method for determining a road condition of a vehicle in one or more embodiments of the present disclosure can be executed by running the computer program.

In summary, the solution for determining a road condition of a vehicle in embodiments of the present disclosure can determine a road condition during autonomous driving of a vehicle with the aid of information provided by a road side unit. The solution does not need to frequently perform map navigation and corresponding processing analysis, so is simpler and more efficient.

The examples above mainly explain the solution for determining a road condition of a vehicle according to the present disclosure. Although only some of the embodiments of the present disclosure have been described, those skilled in the art should understand that the present disclosure can be implemented in many other forms without deviating from the substance and scope thereof. thus, the examples and embodiments presented are regarded as being schematic and non-limiting. The present disclosure could encompass various amendments and substitutions without departing from the spirit and scope of the present disclosure as defined in the attached claims.

What is claimed is:

1. A method for determining a road condition of a vehicle, comprising:
receiving a first signal from a road side unit, the first signal indicating a positional relationship between the vehicle and a specific region; and
determining a road condition of the vehicle on the basis of the first signal.

2. The method as claimed in claim 1, wherein the road side unit is an ETC master computer device located at a boundary of the specific region.

3. The method as claimed in claim 1, wherein the first signal is an ETC signal which indicates that the vehicle is entering or leaving the specific region.

4. The method as claimed in claim 1, wherein the step of determining a road condition of the vehicle on the basis of the first signal comprises:
judging whether a value of the first signal is 1, and if so, determining that the vehicle is currently entering the specific region.

5. The method as claimed in claim 4, wherein the step of determining a road condition of the vehicle on the basis of the first signal further comprises:
when the value of the first signal is 0, determining that the vehicle is currently leaving the specific region.

6. The method as claimed in claim 1, wherein the specific region is a highway, a car park, a microdistrict or a factory area.

7. The method as claimed in claim 1, further comprising:
receiving a second signal from the road side unit, the second signal containing supplementary information for determining a road condition of the vehicle.

8. A device for determining a road condition of a vehicle, comprising:
a first receiving means for receiving a first signal from a road side unit, the first signal indicating a positional relationship between the vehicle and a specific region; and
a determining means for determining a road condition of the vehicle on the basis of the first signal.

9. The device as claimed in claim 8, wherein the road side unit is an ETC master computer device located at a boundary of the specific region.

10. The device as claimed in claim 8, wherein the first signal is an ETC signal which indicates that the vehicle is entering or leaving the specific region.

11. The device as claimed in claim 8, wherein the determining means is configured to judge whether a value of the first signal is 1, and determine that the vehicle is currently entering the specific region when the value of the first signal is 1.

12. The device as claimed in claim 11, wherein the determining means is further configured to determine that the vehicle is currently leaving the specific region when the value of the first signal is 0.

13. The device as claimed claim 8, wherein the specific region is a highway, a car park, a microdistrict or a factory area.

14. The device as claimed in claim 8, further comprising:
a second receiving means for receiving a second signal from the road side unit, the second signal containing supplementary information for determining a road condition of the vehicle.

15. A computer storage medium, wherein the medium comprises instructions which, when run, execute the method for determining a road condition of a vehicle as claimed in claim 1.

16. A vehicle, comprising the device for determining a road condition of a vehicle as claimed in claim 8.
